(19) United States
(12) Patent Application Publication
(10) Pub. No.: US 2013/0044192 A1
(43) Pub. Date: Feb. 21, 2013

(54) CONVERTING 3D VIDEO INTO 2D VIDEO BASED ON IDENTIFICATION OF FORMAT TYPE OF 3D VIDEO AND PROVIDING EITHER 2D OR 3D VIDEO BASED ON IDENTIFICATION OF DISPLAY DEVICE TYPE

(71) Applicants: Debargha Mukherjee, Sunnyvale, CA (US); Jonathan Huang, Santa Clara, CA (US)

(72) Inventors: Debargha Mukherjee, Sunnyvale, CA (US); Jonathan Huang, Santa Clara, CA (US)

(73) Assignee: GOOGLE INC., Mountain View, CA (US)

(21) Appl. No.: 13/450,413

(22) Filed: Apr. 18, 2012

Related U.S. Application Data
(60) Provisional application No. 61/524,667, filed on Aug. 17, 2011.

(51) Int. Cl. H04N 13/04; H04N 7/01

(52) U.S. Cl. 348/51; 348/E13.075; 348/E13.044

(57) ABSTRACT

Aspects of the subject disclosure relate to techniques for extracting a 2D video from a 3D video. A 3D video uploaded by a source is analyzed to identify its 3D format type, for example, a side-by-side, a top and bottom, or frame alternate format. Upon the identification of the 3D format type, 2D video information is extracted from the frames of the 3D video to generate a 2D video. Both the 3D video and 2D video are stored in a database. When a device requests the video, it is determined if the device is associated with a 3D or 2D display device type, and based on that determination either the 2D or the 3D video is provided to the device.

### CROSS-REFERENCE TO RELATED APPLICATION

This application claims priority to U.S. Provisional Patent Application No. 61/524,667, filed on Aug. 17, 2011, and entitled “CONVERTING 3D VIDEO INTO 2D VIDEO BASED ON IDENTIFICATION OF FORMAT TYPE OF 3D VIDEO AND PROVIDING EITHER 2D OR 3D VIDEO BASED ON IDENTIFICATION OF DISPLAY DEVICE TYPE”. The entirety of this application is incorporated herein by reference.

### TECHNICAL FIELD

This disclosure relates to three dimensional videos, and, more particularly, to converting three dimensional (3D) videos into two dimensional (2D) videos and providing either a 2D or 3D video for rendering based on capabilities of a display device.

### BACKGROUND

Conventionally, 3D video was generally created by major motion picture studios or professional production houses for viewing at large theatres or on costly professional equipment. However, recent popularity of 3D video has spurred technology companies to create affordable devices that provide for average consumers to record and view 3D videos. For example, retail mobile phones, cameras, camcorders, and other consumer devices are now able to record 3D video, which can be viewed on a home television or other consumer 3D display device. As such, popular social media sharing sites are receiving uploads of 3D video that users have created to share with family, friends, and/or the general public. Users who have 3D capable display devices can easily download and view an uploaded 3D video in its intended 3D format. However, the vast majority of display devices are still 2D. Thus, a user attempting to view a 3D video on a 2D display device will often see an image that is blurry due to differences in left and right images overlaid in 3D video frames or alternating in consecutive 3D video frames used to create the 3D visual effect.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the purpose of this summary is to present some concepts related to some exemplary non-limiting embodiments in simplified form as a prelude to more detailed description of the various embodiments that follow in the disclosure.

In accordance with a non-limiting implementation, a format recognition component identifies a 3D format type of a 3D video, an extraction component extracts 2D video frames corresponding to 3D video frames from the 3D video based on the 3D format type identified. A collection component generates a 2D video from the extracted 2D video frames, and a device recognition component identifies a display device type associated with a device, and as a function of the identified display device type delivers either the 2D video or the 3D video to the device.

In accordance with another non-limiting implementation, a 3D format type of a 3D video is identified, 2D video frames corresponding to 3D video frames are extracted from the 3D video based on the 3D format type identified. A 2D video is generated from the extracted 2D video frames, and a display device type associated with a device is identified, and as a function of the identified display device type either the 2D video or the 3D video is delivered to the device.

These and other implementations and embodiments are described in more detail below.

### BRIEF DESCRIPTION OF THE DRAWINGS

FIG. 1 illustrates a block diagram of an exemplary non-limiting three-dimensional 3D video capture system in accordance with an implementation of this disclosure.

FIG. 2 illustrates a block diagram of an exemplary non-limiting 3D video to 2D video conversion and distribution system in accordance with an implementation of this disclosure.

FIG. 3A illustrates an exemplary non-limiting 2D video frame in accordance with an implementation of this disclosure.

FIG. 3B illustrates an exemplary non-limiting 3D video frame having a side-by-side format type in accordance with an implementation of this disclosure.

FIG. 3C illustrates an exemplary non-limiting 3D video frame having a top and bottom format type in accordance with an implementation of this disclosure.

FIG. 4A illustrates an exemplary non-limiting flow diagram for converting a 3D video into a 2D video and storing the 3D and 2D videos in accordance with an implementation of this disclosure.

FIG. 4B illustrates an exemplary non-limiting flow diagram for providing either 3D or 2D video depending on a display device type associated with a device that is the intended recipient of a requested video in accordance with an implementation of this disclosure.

FIG. 5 an exemplary non-limiting flow diagram for converting a 3D video into a 2D video in accordance with an implementation of this disclosure.

FIGS. 6A and 6B illustrate an exemplary method for determining if a 3D video contains a side-by-side format type in accordance with an implementation of this disclosure.

FIG. 8 is a block diagram representing an exemplary non-limiting networked environment in which the various embodiments can be implemented.

FIG. 9 is a block diagram representing an exemplary non-limiting computing system or operating environment in which the various embodiments can be implemented.

### DETAILED DESCRIPTION

### Overview

Various aspects or features of this disclosure are described with reference to the drawings, wherein like reference numerals are used to refer to like elements throughout. In this specification, numerous specific details are set forth in order to provide a thorough understanding of this disclosure. It should be understood, however, that certain aspects of this disclosure may be practiced without these specific details, or with other methods, components, materials, etc. In other instances, well-known structures and devices are shown in block diagram form to facilitate describing this disclosure.

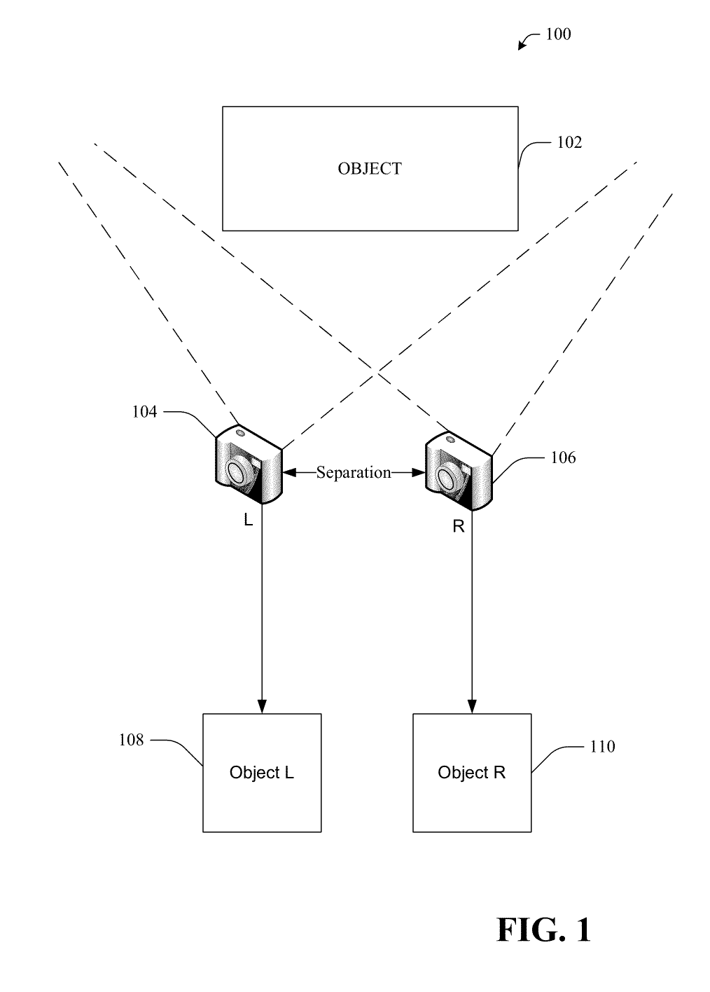

FIG. 1 illustrates an exemplary system 100 for capturing a 3D video. 3D video is a generic term for a display technology that allows viewers to experience video content with stereoscopic effect. 3D video provides an illusion of a third dimension (e.g., depth) to current video display technology, which is typically limited to only height and width (2D). A 3D device works much like 3D at a movie theater. A screen showing 3D content concurrently displays two separate images of a same object 102. One image (right image) is intended for a viewer's right eye (R) and is captured by using R-camera 106. The other image (left image) is intended for the left eye (L) and is captured by using L-camera 104. It is to be understood that the left and right images can be captured at substantially the same time, however this is not required. For example, in a captured scene where there is motion of object in the scene, the left and right images may be captured at substantially the same time. In another example, if there is no motion in the scene, then the left and right images can be captured at differing times.

Two images 108 and 110 captured by the L and R cameras 104 and 106 respectively comprise a 3D frame that occupy an entire screen and appear intermixed with one another. It is to be understood that the images 108 and 110 can be compressed or uncompressed in the 3D frame. Specifically, objects in one image are often repeated or skewed slightly to the left (or right) of corresponding objects in the other image, when viewed without aid of special 3D glasses. When viewers wear the 3D glasses, they perceive the two images as a single 3D image because of a process known as “fusing.” Such 3D system(s) rely on a phenomenon of visual perception called stereopsis. Eyes of an adult generally reside about 2.5 inches apart, which enables each eye to see objects from a slightly different angle than the other. The left and right images in a 3D video are captured by using the L and R cameras 108 and 110 that are not only separated from each other by a few centimeters but also may capture the object 102 from two different angles. When the images combine in the viewer's mind with the aid of the glasses, the illusion of depth is created.

Devices that generate 3D video have reached a price point that has afforded for creation of vast amounts of 3D video content. Such 3D video is frequently uploaded from 3D cameras in specific formats, which will not display correctly on 2D devices. 2D devices are somewhat ubiquitous in the consumer retail market, and consequently the formatting that provides the illusion of depth in a 3D video can result in distortion (e.g., fuzziness, blurriness, appearing as two images instead of one, etc.) when viewed using a 2D device. Embodiments described herein mitigate the aforementioned issue by reformatting content so that it automatically displays correctly on 3D devices as well as 2D devices by passing through the 3D video for devices having a 3D display device type, and converting the 3D video to a 2D video for devices having a 2D display device type.

In accordance with various disclosed aspects, a mechanism is provided for detecting a 3D format type of a 3D video and creating a 2D video from the 3D video based on the detected 3D format type. Furthermore, a mechanism in provided for detecting a display device type associated with a device and presenting a 3D or 2D video based on detected display type. In a non-limiting example, a user can upload a 3D video and other users can view the video in 3D or 2D based upon display capabilities of a rendering device. For example, a 3D video that is uploaded to a social media site can be stored in 3D format, as well as, be converted and stored in a 2D format. Upon the video being requested for viewing, the social media site can determine the display device type of a requesting device, such as a tablet device, and present a 3D format video if the device can render 3D format, otherwise a 2D format video is presented to the device. In another example, a subscribed movie streaming service can detect display device type associated with a device. For example, a DVD player that has a movie streaming service can be associated with a 3D capable television or a 2D capable television. The movie streaming service can determine the display device type of the associated television and present a 3D or 2D format video as appropriate to the DVD player.

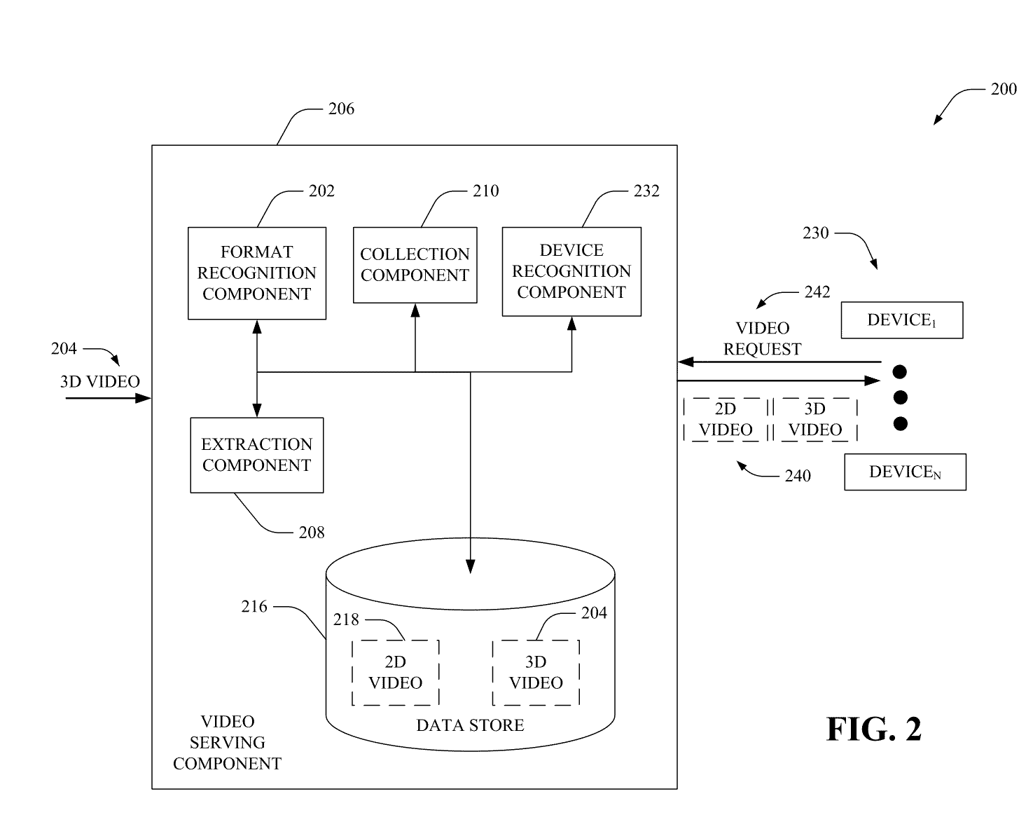

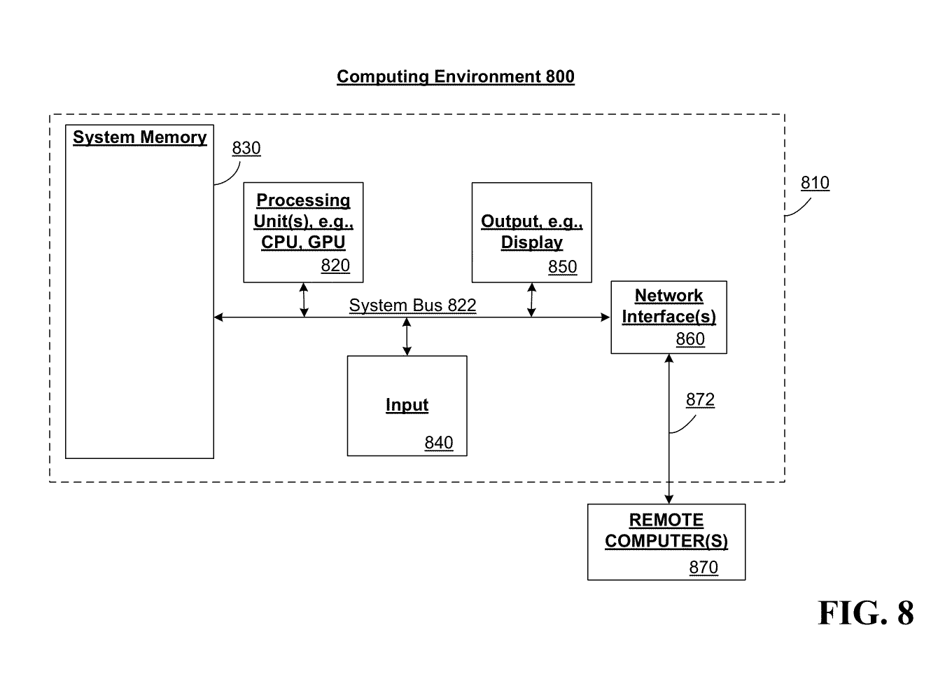

FIG. 2 illustrates a system 200 in accordance with an embodiment. System 200 includes video serving component 206 that receives 3D videos 204 and provides 3D or 2D videos to devices 230. Video serving component 206 and devices 230 can receive input from users to control interaction with and presentation on video serving component 206 and devices 230, for example, using input devices, non-limiting examples of which can be found with reference to FIG. 8.

Video serving component 206 includes a memory that stores computer executable components and a processor that executes computer executable components stored in the memory, a non-limiting example of which can be found with reference to FIG. 8. In one implementation, video serving component 206 can be located on a server communicating via a network, wired or wireless, with devices 230. For example, video serving component 206 can be incorporated into a video server (e.g., that of a social media sharing website, cable television provider, satellite television provider, subscription media service provider, internet service provider, digital subscriber line provider, mobile telecommunications provider, cellular provider, radio provider, or any other type of system that provides videos or video streams via wired or wireless mediums) that provides videos to devices 230. In another implementation, video serving component 206 can be incorporated into device 230. Furthermore, videos may be stored local to video serving component 206 or may be stored remotely from video serving component 206.

Device 230 can be any suitable type of device for interacting with videos locally, or over a wired or wireless communication link, non-limiting examples of which include, a mobile device, a mobile phone, personal data assistant, laptop computer, tablet computer, desktop computer, server system, cable set top box, satellite set top box, cable modem, television set, media extender device, blu-ray device, DVD (digital versatile disc or digital video disc) device, compact disc device, video game system, audio/video receiver, radio device, portable music player, navigation system, car stereo, etc.

With continued reference to FIG. 2, video serving component 206 includes a format recognition component 202 that identifies 3D format type associated with a 3D video 204. Video serving component 206 also includes an extraction component 208 that extracts 2D frames from 3D video 204 based on the 3D format type identified. Video serving component 206 further includes a collection component 210 that stores the extracted 2D frames collectively as a 2D formatted video in a data store 216. In addition, video serving component 206 includes a device recognition component 232 that can identify device display type of a device. Video serving component 206 also includes data store 216 that can store videos, as well as, data generated by format recognition component 202, extraction component 208, collection component 210, or device recognition component 232. Data store 120 can be stored on any suitable type of storage device, non-limiting examples of which are illustrated with reference to FIGS. 7 and 8.

Video serving component 206 receives one or more 3D videos 204 from one or more sources, non-limiting examples of which include, a user upload, a device, a server, a broadcast service, a media streaming service, a video library, a portable storage device, or any other suitable source from which a 3D video can be provided to video serving component 206 via a wired or wireless communication medium. It is to be understood that video serving component 206 can receive and process a plurality of 3D videos concurrently from a plurality of sources. Video serving component 206 can store the received 3D videos 204 in their original uploaded format or in a compressed form in data store 216. In addition, the source can specify that a 2D version of the video should not be created for a 3D video 204, and video serving component 206 can mark the 3D video 204 as 3D only and not perform a conversion to 2D. For example, a creator of a 3D video 204 may not want a 2D version of the 3D video in order to maintain creative integrity of his 3D video.

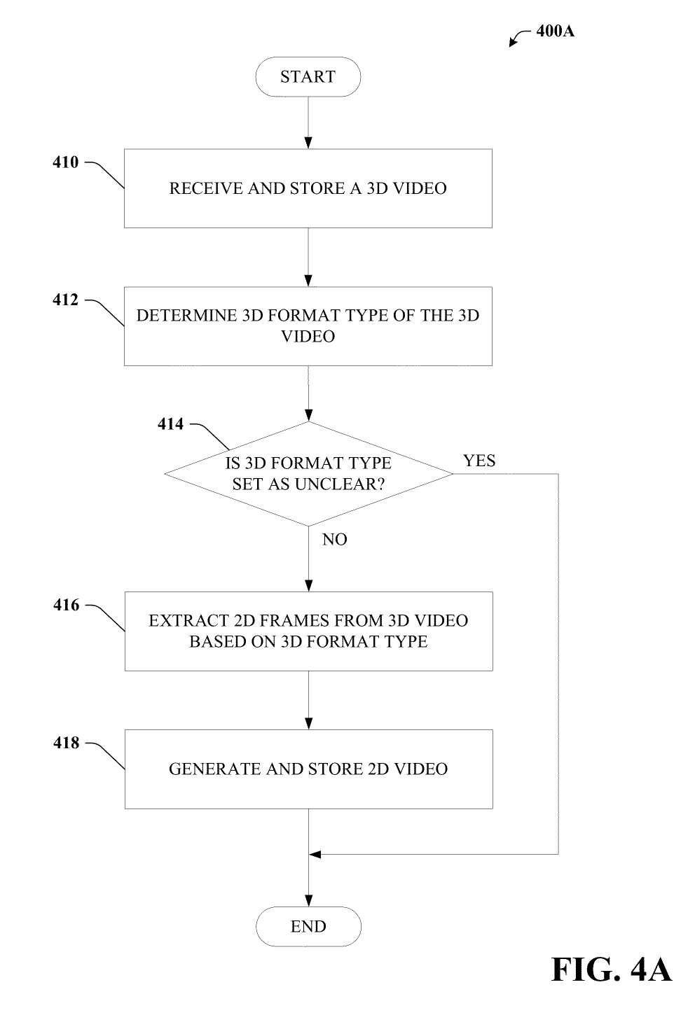

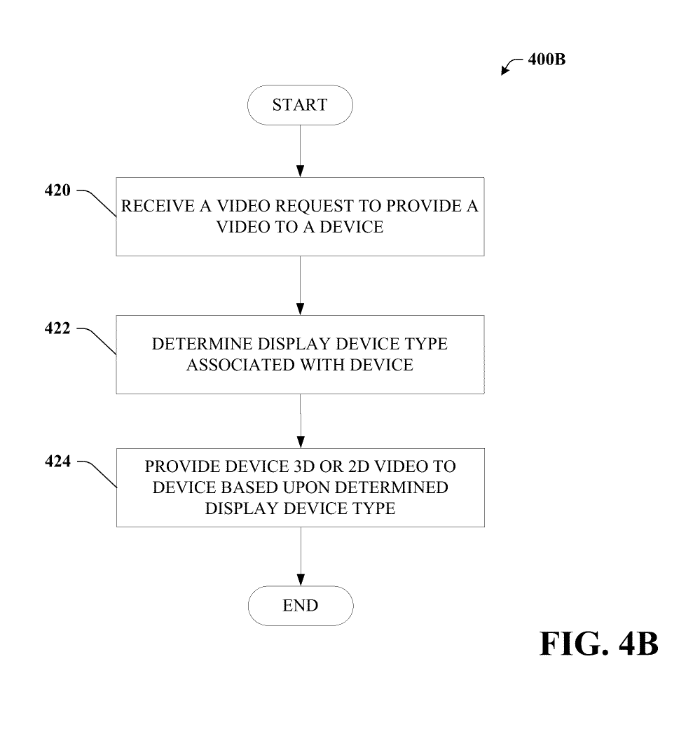

Format recognition component 202 can analyze the 3D video 204 to determine 3D format type of the 3D video. Non-limiting examples of 3D format types are side-by-side format, top and bottom, or interlaced (frame alternate or alternating) format. FIG. 4 depicts non-limiting examples of a 2D video frame, side-by-side video frame, and top-and bottom video frame. A side-by-side format comprises a series of 3D frames where an associated left (left frame) and right (right frame) captured 2D image of a scene are incorporated into a single 3D frame as side-by-side 2D frames. For example, a left captured image of a scene can be scaled and included in the left ˜50% of the 3D frame and a right captured image of the same scene can be scaled and included in the right ˜50% of the same 3D frame, or vice versa. Likewise, subsequent captured left and right images of the same or different scene would be scaled and incorporated side-by-side into corresponding subsequent single 3D frames in a series of 3D frames of a 3D video. A top and bottom format comprises a series of 3D frames where an associated left (left frame) and right (right frame) captured image of a scene are incorporated into a single 3D frame as top and bottom 2D frames. For example, a left captured image of a scene can be scaled and included in the top ˜50% of the 3D frame and a right captured image of the same scene can be scaled and included in the bottom ˜50% of the same 3D frame, or vice versa. Similarly, subsequent captured left and right images of the same or different scene would be scaled and incorporated top and bottom into corresponding subsequent single 3D frames in a series of 3D frames of a 3D video. An alternating format comprises a series of 3D frames where an associated left (left frame) and right (right frame) captured image of a scene are incorporated into two consecutive 3D frames. It is to be appreciated that the 3D frames can be 2D frames in series alternating between left and right captured images. For example, a left captured image of a scene can be included as a 2D left frame in a first 3D frame and a right captured image of the same scene can be included as a 2D right frame in a second 3D frame immediately following the first 3D frame in a series of frames, or vice versa. Correspondingly, subsequent captured left and right images of the same or different scene can be incorporated into consecutive alternating 3D frames in a series of 3D frames of a 3D video.

Format recognition component 202 can examine a 3D frame or a pair of consecutive frames of 3D video 204 to determine 3D format type. For example, format recognition component 202 can compare a first 2D frame extracted from a left portion of the 3D frame and second 2D frame extracted from a right portion of the 3D frame to determine if they represent left and right image captures of a scene. In a non-limiting example, a color histogram can be created for the first 2D frame of the 3D frame, which can be compared to a color histogram of the second 2D frame of the 3D frame. In another non-limiting example, a motion estimation comparison can be performed between the first 2D frame and second 2D frame of the 3D frame. It is to be understood that any suitable comparison can be performed between the first 2D frame and second 2D frame of the 3D frame to determine degree to which they match. Based on the comparison, format recognition component 202 can assign a side-by-side measure indicating degree to which the first 2D frame and second 2D frame of the 3D frame match. Format recognition component 202 can compare the side-by-side measure to a matching confidence threshold to determine whether the first 2D frame and second 2D frame of the 3D frame sufficiently match to a level that would provide confidence that the 3D format type is side-by-side. If the side-by-side measure exceeds the matching confidence threshold, format recognition component 202 can assign side-by-side as the 3D format type for 3D video 204. Otherwise, additional 3D frames of 3D video 204 can be examined until the side-by-side measure exceeds the matching confidence threshold or a predetermined number of frames have been examined. For example, if the predetermined number of frames has been met without assigning the 3D format type as side-by-side, format recognition component 202 can assign unclear as the 3D format type. It is to be appreciated that the side-by-side measure can be a cumulative measure over a series of frames, non-limiting example of which include mean, median, or any other probabilistic or statistical measure. The predetermined number of frames can be any number of suitable frames within the 3D video 204, non-limiting examples of which include, one frame, a subset of the frames, a percentage of the frames, all frames. Furthermore, the predetermined number of frames can be, for example, predefined in the system, set by an administrator, user, or can be dynamically adjusted, for example, based on hardware processing capabilities, hardware processing load, 3D video 204 size, or any other suitable criteria.

In another non-limiting example, format recognition component 202 can perform a top and bottom comparison similar to the side-by-side analysis discussed above. For example, format recognition component 202 can compare a first 2D frame extracted from a top portion of the 3D frame and second 2D frame extracted from a bottom portion of the 3D frame to determine if they represent left and right image captures of a scene. It is to be understood that any suitable comparison can be performed between the first 2D frame and second 2D frame of the 3D frame to determine degree to which the two portions match, non-limiting examples of which include color histogram and motion estimation. Based on the comparison, format recognition component 202 can assign a top and bottom measure indicating the degree to which the first 2D frame and second 2D frame of the 3D frame match. Format recognition component 202 can compare the top and bottom measure to a matching confidence threshold to determine whether the first 2D frame and second 2D frame of the 3D frame sufficiently match to a level that would provide confidence that the 3D format type is top and bottom. If the top and bottom measure exceeds the matching confidence threshold, format recognition component 202 can assign top and bottom as the 3D format type for 3D video 204. Otherwise, additional 3D frames of 3D video 204 can be examined until the top and bottom measure exceeds the matching confidence threshold or a predetermined number of frames have been examined. For example, if the predetermined number of frames has been met without achieving without assigning the 3D format type as top and bottom, format recognition component 202 can assign unclear as the 3D format type. It is to be appreciated that the top and bottom measure can be a cumulative measure over a series of frames, non-limiting example of which include mean, median, or any other probabilistic or statistical measure.

In further non-limiting example, format recognition component 202 can perform an alternating comparison similar to the side-by-side and top and bottom analyses discussed above. For example, format recognition component 202 can compare a first a 3D frame in a consecutive pair of 3D frames to a second frame in the consecutive pair of 3D frames to determine if they represent left and right image captures of a scene. It is to be understood that any suitable comparison can be performed between the first and second 3D frames to determine degree to which the two frames match, non-limiting examples of which include color histogram and motion estimation. Based on the comparison, format recognition component 202 can assign an alternating measure indicating the degree to which the first and second 3D frames match. Format recognition component 202 can compare the alternating measure to a matching confidence threshold to determine whether the first and second 3D frames sufficiently match to a level that would provide confidence that the 3D format type is alternating. If the alternating measure exceeds the matching confidence threshold, format recognition component 202 can assign alternating as the 3D format type for 3D video 204. Otherwise, additional consecutive pairs of 3D frames of 3D video 204 can be examined, such as a sliding window of two consecutive frames in the series of 3D frames can be incremented by one or two frames, until the alternating measure exceeds the matching confidence threshold or a predetermined number of frames have been examined. For example, if the predetermined number of frames has been met without achieving without assigning the 3D format type as alternating, format recognition component 202 can assign unclear as the 3D format type. It is to be appreciated that the alternating measure can be a cumulative measure over a series of frames, non-limiting example of which include mean, median, or any other probabilistic or statistical measure.

Format recognition component 202 can perform an analysis for side-by-side, top and bottom, or alternating concurrently for a 3D video 204 until a 3D format type is determined for 3D video 204, for example, when one of the side-by-side measure, top and bottom measure, or alternating measure have exceeded the matching confidence threshold. Furthermore, an analysis for side-by-side, top and bottom, or alternating concurrently for a 3D video 204 can be performed in series. Additionally, if performed in series, the order can vary, for example, based upon a 3D format type that is most commonly used, a 3D format type that has be recognized most often by format recognition component 202, based upon administrator configuration, or any other suitable criteria. Furthermore, if two or more of the side-by-side measure, top and bottom measure, or alternating measure have exceeded the matching confidence threshold, a tiebreaker mechanism can be employed. For example, an additional matching confidence threshold can be used that is higher than the matching confidence threshold. When one of the side-by-side measure, top and bottom measure, or alternating measure have exceeded the additional matching confidence threshold, the 3D format type of the 3D video 204 can be set accordingly. In a further example, the side-by-side measure, top and bottom measure, or alternating measure that has exceeded the matching confidence threshold by the greatest amount can be chosen as the 3D format type for 3D video 204. In another example, format recognition component 202 can assign unclear as the 3D format type for 3D video 204 if two or more of the side-by-side measure, top and bottom measure, or alternating measure have exceeded the matching confidence threshold or the additional matching confidence threshold. It is to be understood that the tiebreaker mechanism be predefined or configurable, for example, by an administrator. Moreover, if all three measures do not exceed the matching confidence threshold or the additional matching confidence threshold format recognition component 202 can assign unclear as the 3D format type for 3D video 204. It is also to be understood that the matching confidence threshold can vary for each of the side-by-side measure, top and bottom measure, or alternating measure.

Format recognition component 202 can be automatically triggered upon the receiving of the 3D video, can be manually triggered, or can be programmed to trigger upon detection of an event or a condition, a non-limiting example of which includes identification of a particular source from which the 3D video is received.

Extraction component 208 extracts respective 2D frames from corresponding 3D frames of 3D video 204, based on the 3D format type assigned. If the 3D format type is unclear, extraction component 208 does not extract 2D frames from 3D video 204. If the 3D format is side-by-side, extraction component 208 will extract 2D frames from either the left or right portions for all consecutive frames in 3D video 204 and maintain their order. Furthermore, extraction component 208 can scale the extracted 2D frame to the size of a full 2D frame. In a non-limiting example, the extracted 2D frame can be stretched horizontally by ˜100%. In one example, 2D frames from the left portion of all 3D frames in 3D video 204 are extracted to create the 2D video. In another example, 2D frames from the right portion of all 3D frames in 3D video 204 are extracted to create the 2D video. While this example discloses extracting 2D frames from all 3D frames, it is to be appreciated that 2D frames can be extracted from a subset of the 3D frames, for example, to meet a particular 2D video quality. For example, 2D frames can be extracted from every j 3D frames, where j is an integer to produce a lower quality 2D video. If the 3D format type is top and bottom, extraction component 208 will extract 2D frames from either the top or bottom portions for 3D frames in 3D video 204 and maintain their order. Furthermore, extraction component 208 can scale the extracted 2D frames to the size of a full 2D frame. In a non-limiting example, the extracted 2D frames can be stretched vertically by ˜100%. It one example, 2D frames from the top portion of all 3D frames in 3D video 204 are extracted to create the 2D video. In another example, 2D frames from the bottom portion of all 3D frames in 3D video 204 are extracted to create the 2D video. If the 3D format type is alternating, extraction component 208 will extract 2D frames from either the odd numbered or even numbered 3D frames from the consecutively numbered 3D frames in 3D video 204 and maintain their order. It one example, 2D frames from the odd numbered 3D frames in 3D video 204 are extracted to create the 2D video. In another example, 2D frames from the even numbered 3D frames in 3D video 204 are extracted to create the 2D video.

Optionally, extraction component 208 can utilize frame coherence to improve 2D frame quality. In an embodiment, extraction component 208 can utilize standard bilinear interpolation using both left and right frames to generate higher quality full 2D frames. Likewise, it is to be appreciated that a right frame can be employed to improve quality of a 2D frame generated from a left frame and vice versa.

Collection component 210 can store the extracted 2D frames collectively as a 2D formatted video 218 in data store 216. For example, collection component can perform a video encoding algorithm on the extracted 2D frames to generate a 2D video 218. It one example, the 3D video 204 and a corresponding 2D video 218 generated from 3D video 204 can be stored in a single video file by collection component 210. For example, this may be advantageous for portability of the 3D and 2D video. In an alternative example, collection component 210 can store the 2D video 218 and the corresponding 3D video 204 as separate files (e.g., to mitigate computation overhead at request time).

Video serving component 206 can receive a video request 242 to provide a video to N devices 230 (N is an integer), where N can be any number of devices. It is to be appreciated that video serving component 206 can receive and process a plurality of video requests 242 concurrently. Furthermore, while FIG. 2 depicts video request 242 coming from devices 230, video request 232 can originate from any source. For example, a video subscription service can initiate a video request 242 for video serving component 206 to push a video to a one or more device 230. The respective devices 230 can have different capabilities (e.g., can only process 2D video, can only process 3D video, can process multiple types of video . . . ). A device that can only process 2D video will have difficulty displaying 3D video. Accordingly, a device recognition component 232 can identify a display device type associated with a device 230. In a non-limiting example, display device type can be 3D display for devices that are designed for 3D video or designed for 3D video and 2D video, and 2D display for devices that are not designed for 3D video. In an example, video request 242 for device 230 can include information identifying a display device type associated with device 230. In another example, video request 242 can provide information that allows device recognition component 232 to infer display device type of device 230. For example, video request 232 can provide a device type, such as a product, model, or serial number, which device recognition component 232 can use to look up characteristics of the device in a device profile, device library, or on the internet. In a further example, video request 242 can provide information identifying a user associated with device 230 which device recognition component 232 can use to look up a profile associated with the user in order to identify video format preferences for the device 230. In yet another example, device recognition component 232 can query device 230 for information to identify the display device type associated with device 230. For example, device recognition component 232 can query device 230, a DVD player or cable box, for information regarding a television connected to the device 230 in order to determine the display device type.

If device recognition component 232 determines that the display device type of device 230 is 3D display, video serving component 206 can supply a 3D video of the requested video to device 230. If device recognition component 232 determines that the display device type of device 230 is 2D display, video serving component 206 can supply a 2D video of the requested video to device 230. However, if device recognition component 232 determines that the display device type of device 230 is 2D display and a 2D video of the 3D video was not generated, for example, because of source specification not to create a 2D video or because the 3D format type was set as unclear, an error message can be sent to device 230, the 3D video can be sent to device 230, or a query can sent to device 230 informing device 230 that a 2D video is not available and asking if a 3D is desired. It is to be further appreciated that video request 242 can specify 2D format or 3D format as a requested video format. For example, video request 242 can specify 2D video and if a 2D video of the 3D video was not generated, an error message be sent to device 230, the 3D video can be sent to device 230, or a query can sent to device 230 informing device 230 that a 2D video is not available and asking if a 3D video should be supplied. In another example, video request 242 can specify 2D video and if device recognition component 232 determines that the display device type of device 230 is 3D display, the 3D video can be sent to device 230, or a query can sent to device 230 informing device 230 that a 3D video is available and asking if a 3D video should be supplied. It is to be further appreciated that if a 2D video is not available for a 3D video, video serving component 206 can forego employing device recognition component 232 to determine a display device type, and send the 3D video to device 230. Furthermore, in a non-limiting example, it should be appreciated that if device recognition component 232 cannot determine a display device type associated with device 230, device recognition component 232 can query the device as to a requested video format, 3D or 2D. In an alternative example, if device recognition component 232 cannot determine a display device type associated with device 230, video serving component 206 can provide a video format indicated in the video request 242 or a default video format as predefined in the system, for example, by an administrator.

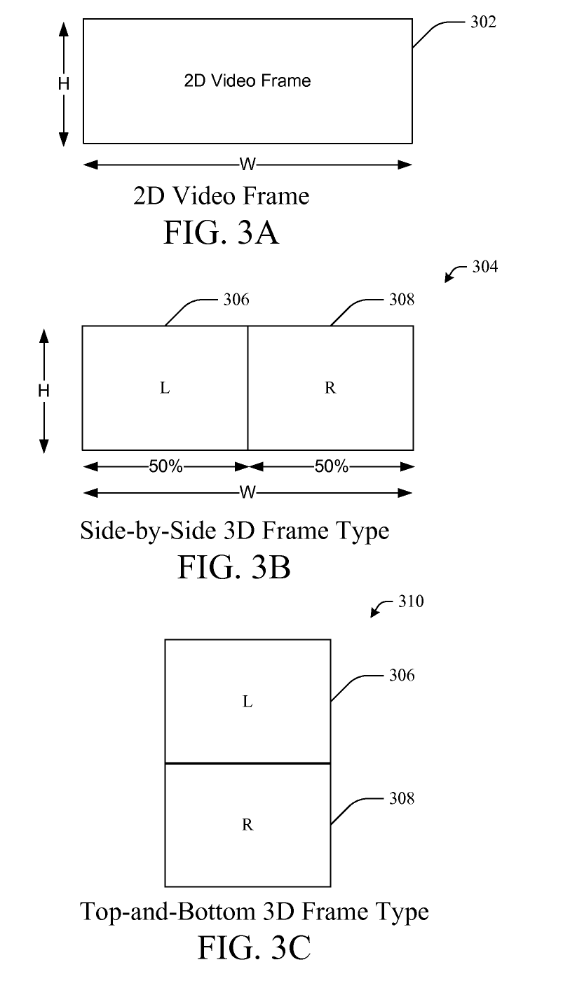

Referring to FIGS. 3A-C, exemplary video frames are depicted. FIG. 3A illustrates an exemplary 2D video frame 302. The 2D video frame 302 has a height and a width, which are typically defined by the number of pixels. For example, the 2D video frame 302 can have a width of 640 pixels and a height of 480 pixels. In another example, the 2D video frame can have a width of 420 pixels and a height of 240 pixels. FIG. 3B illustrates an exemplary 3D video frame 304 having a side-by-side 3D format type. The 3D video frame 304 is composed of left and right frames 306 and 308, side-by-side, but compressed by ˜50% width in comparison to the 2D video frame 302. FIG. 3C illustrates an exemplary 3D video frame 310 having the left and right frames 306 and 308 in a top and bottom 3D format type.

According to an aspect of the subject disclosure, an extraction component can extract a 2D frame from the 3D video frame 304 by stretching (or scaling) either the left frame 306 or the right frame 308 by ˜100% to create a full frame. The extraction component can also extract a 2D frame from the 3D frame 304 by combining the data from the left frame 306 and the right frame 308. For example, when re-sampling the left image to create the corresponding 2D frame, scaling algorithm employed by the extraction component can exploit frame coherence from a corresponding right frame to assist in scaling, or vice versa. According to another aspect of the subject disclosure, in the case of images taken by a known 3D camera that has two cameras side-by-side, separated by a fixed distance in a specific direction, for example five centimeters, the rescaling algorithm can sample from the right frame to fill information missing from the left frame, during the extraction process of the 2D frame using the fixed distance. In the five centimeter example, if the five centimeters map to fifty pixels, a bilinear interpolation based scalar can average the color related data selected from both the left and right frames, by associating pixels in the left frame to pixels in the right frame by an offset of fifty pixels in the specific direction, to produce a more accurate 2D frame.

FIGS. 4A-6B illustrate various methodologies in accordance with certain disclosed aspects. While, for purposes of simplicity of explanation, the methodologies are shown and described as a series of acts, it is to be understood and appreciated that the disclosed aspects are not limited by the order of acts, as some acts may occur in different orders and/or concurrently with other acts from that shown and described herein. For example, those skilled in the art will understand and appreciate that a methodology can alternatively be represented as a series of interrelated states or events, such as in a state diagram. Moreover, not all illustrated acts may be required to implement a methodology in accordance with certain disclosed aspects. Additionally, it is to be further appreciated that the methodologies disclosed hereinafter and throughout this disclosure are capable of being stored on an article of manufacture to facilitate transporting and transferring such methodologies to computers.

FIG. 4A depicts an exemplary method 400A for converting a 3D video into a 2D video and storing the 3D and 2D videos. At reference numeral 410, a 3D video is received and stored. (e.g. by a video serving component 206) At reference numeral 412, a 3D format type of the 3D video is determined. (e.g. by a format recognition component 202) At reference numeral 414, a determination is made whether the 3D format type for the video has been set to unclear. (e.g. by an extraction component 208) If the decision at 414 is true or “YES” indicating that the 3D format type is set to unclear then the method ends. If the decision at 414 is false or “NO” indicating that the 3D format type is not set to unclear then the method proceeds to reference numeral 416. At reference numeral 416, 2D frames are extracted from the 3D video according to the 3D format type determined at reference numeral 412. (e.g. by a extraction component 208) At reference numeral 418, the extracted 2D frames are used to generate and store a 2D video of the 3D video. (e.g. by a collection component 210)

FIG. 4B depicts an exemplary method 400B for providing either 3D or 2D video depending on a display device type associated with a device that is the intended recipient of a requested video. At reference numeral 420, a request for a video to provide to a device is received. (e.g. by a video serving component 206) At reference numeral 422, a display device type associated with the device is determined. (e.g. by a device recognition component 232) At reference numeral 424, a 3D or 2D video as appropriate is provided to the device based upon the display device type associated with the device determined at reference numeral 422. (e.g. by a device recognition component 232)

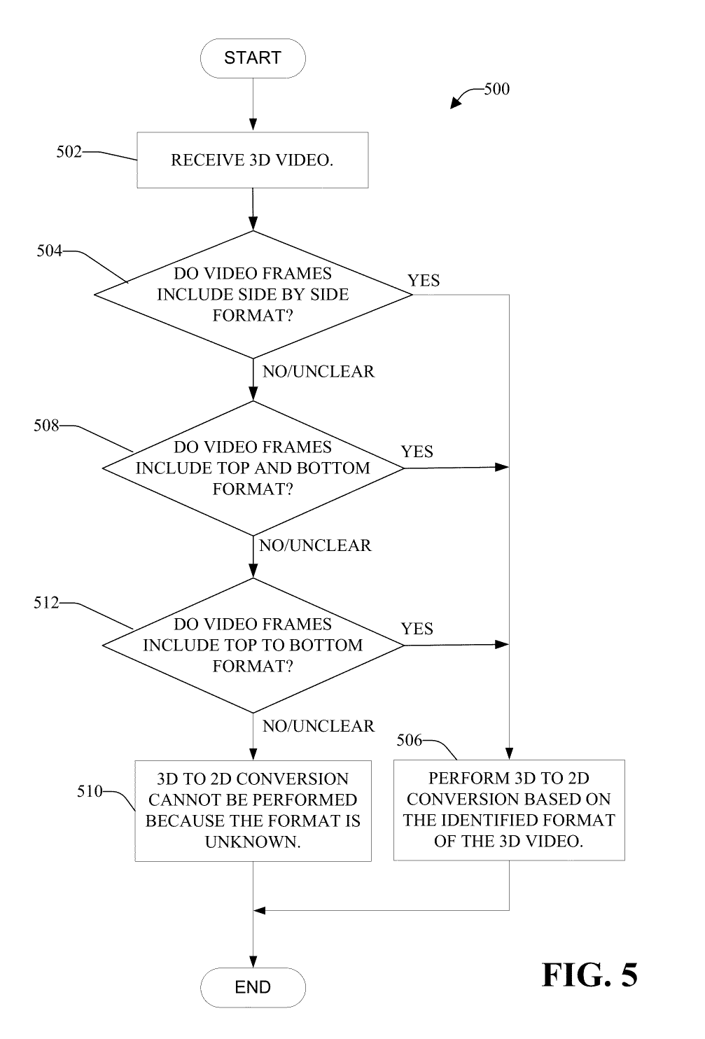

FIG. 5 illustrates an exemplary method 500 for converting a 3D video into a 2D video. At 502, a 3D video is received for storage from a source. (e.g. by a video serving component 206) In one embodiment, the 3D video is automatically processed for conversion into a 2D video. At 504, it is determined if the 3D video contains a side-by-side 3D format type. (e.g. by a format recognition component 202) If the 3D video contains a side-by-side 3D format type, at 506, the 3D video is converted into a 2D video by applying the appropriate techniques for a side-by-side 3D video (e.g. by an extraction component 208 and/or a collection component 210). If the 3D format type is unclear or determined not to be side-by-side at 504, at 508, it is determined if the 3D video contains a top and bottom 3D format type (e.g. by a format recognition component 202) If the 3D video contains a top and bottom 3D format type, at 506, the 3D video is converted into a 2D video by applying the appropriate techniques for a top and bottom 3D video (e.g. by an extraction component 208 and/or a collection component 210). If the 3D format type is unclear or determined not to be top and bottom at 508, it is determined if the 3D video contains an alternating 3D format type (e.g. by a format recognition component 202). If the 3D video contains an alternating 3D format type, at 510, the 3D video is converted into a 2D video by applying the appropriate techniques for an alternating 3D video (e.g. by an extraction component 208 and/or a collection component 210). If the 3D format type is unclear or determined not to be top and bottom at 510, at 512, it is concluded that the 3D video cannot be converted into a 2D video (e.g. by a format recognition component 202).

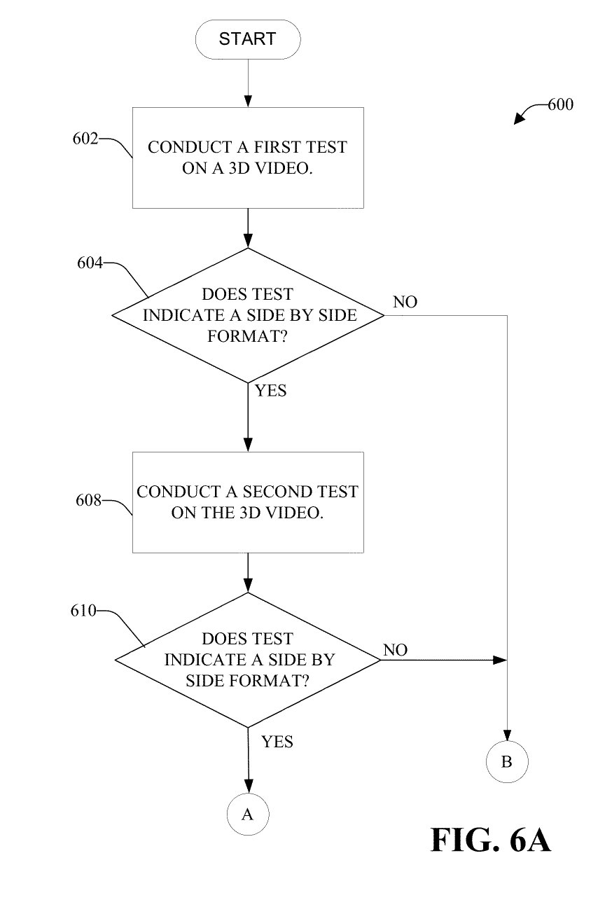

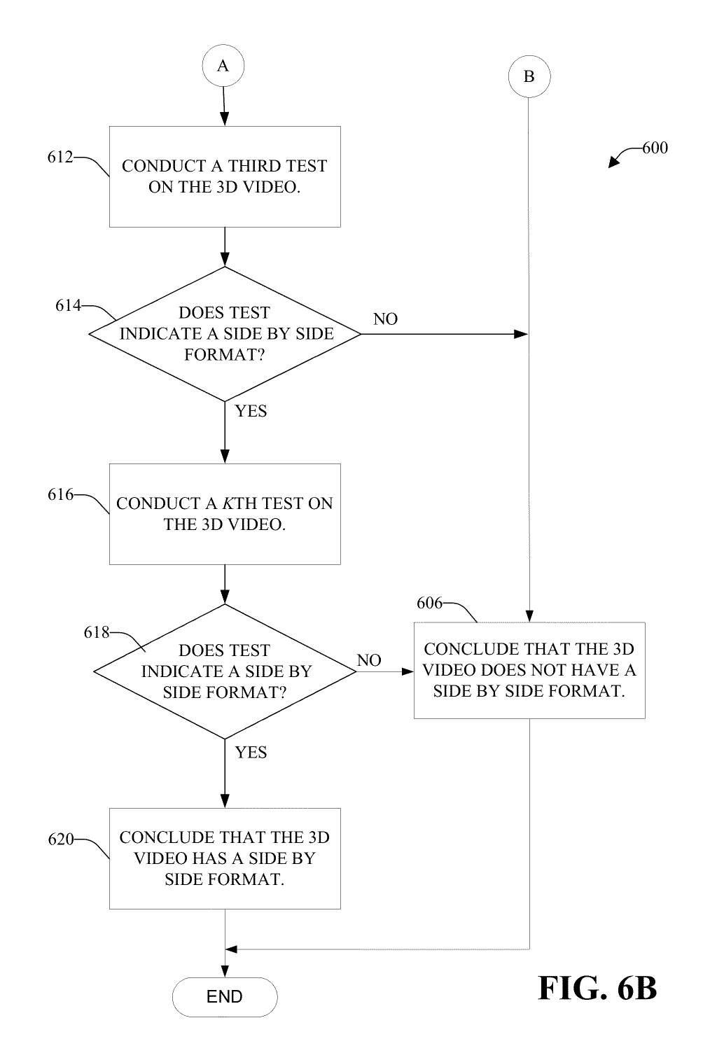

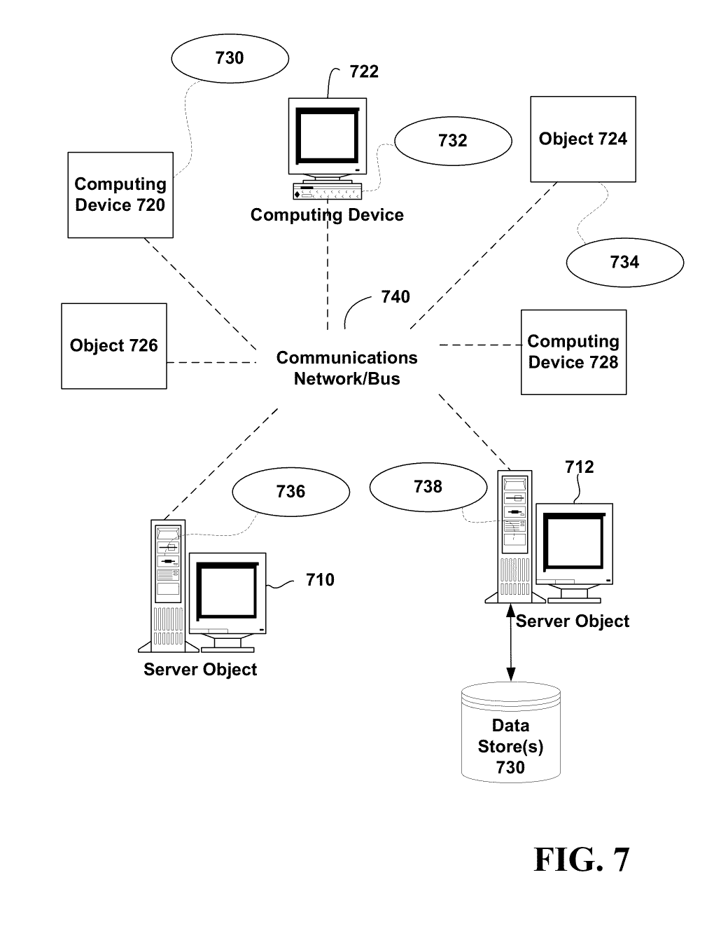

FIGS. 6A and 6B illustrate an exemplary method for determining if a 3D video contains a side-by-side 3D format type (e.g. by a format recognition component 202). At 602, a first test is conducted to determine if a 3D video contains a side-by-side 3D format type. An example of the testing performed at 602, and generally in the method 600 at 608, 612 and 616, includes dividing a 3D frame of the 3D video horizontally into two halves and comparing corresponding color histograms of the two halves to determine if they match or have substantial similarities. The testing is based on an assumption that 3D video has a side-by-side 3D format type and so the 3D frame includes L and R images of the same object containing nearly identical images in the two horizontal halves. Another example of the testing performed in the method 600 includes comparing motion estimation data in the subsequent 3D frames with respect to the left and right halves. Yet another example of the testing performed in the method 600 includes comparing global motion component analysis in the subsequent 3D frames with respect to the left and right halves, and observing, for example, if global motion is translational for each half. In one implementation, at 604, if the first test indicates that the likelihood of the 3D video having a side-by-side 3D format type is above a predetermined threshold, then a second test is conducted at 608. In another implementation, if the first test indicates that the likelihood of the 3D video having a side-by-side 3D format type is above a predetermined threshold, then it can be concluded that the 3D video has a side-by-side 3D format type. However, if the first test does not indicate that the likelihood of the 3D video having a side-by-side 3D format type is above a predetermined threshold, then it can be concluded at 606 that the 3D video does not have a side-by-side 3D format type.

In one implementation, at 610, if it is determined that the second test also indicates that the likelihood of the 3D video having a side-by-side 3D format type is above a predetermined threshold, then a third test is conducted at 612. In another implementation, if the second test also indicates that the likelihood of the 3D video having a side-by-side 3D format type is above a predetermined threshold, then it is concluded that the 3D video has a side-by-side 3D format type. However, if the second test does not indicate that the likelihood of the 3D video having a side-by-side 3D format type is above a predetermined threshold, then it can be concluded at 606 that the 3D video does not have a side-by-side 3D format type.

In an implementation, the above testing process is repeated three times at 612 and 614. In another implementation, the above testing process is repeated at 616 and 618. In one implementation, if every one of the K tests (where K is an integer) indicates that likelihood of the 3D video having a side-by-side 3D format type is above a predetermined threshold, it can be concluded that the 3D video contains a side-by-side 3D format type at 620. In that case, a 2D video extraction of the 3D video is performed by using techniques appropriate for a side-by-side 3D format type 3D video. According to an aspect, each test is performed on many frames of the 3D video, for example, one hundred frames or one thousand frames.

It is to be appreciated that a method similar to the method 600 can be employed to determine if a 3D video contains a top and bottom or alternating 3D format type. In one embodiment, the initial testing is performed to determine if the 3D video has a side-by-side 3D format type because the video is likely to have a side-by-side 3D format type based on, for example, the source of the video. In another embodiment, the initial testing is performed to determine if the 3D video has a top and bottom 3D format type because the video is likely to have a top and bottom 3D format type based on, for example, the source of the video. In a further embodiment, the initial testing is performed to determine if the 3D video has an alternating 3D format type because the video is likely to have an alternating 3D format type based on, for example, the source of the video.

### Exemplary Networked and Distributed Environments

One of ordinary skill in the art can appreciate that the various embodiments of dynamic composition described herein can be implemented in connection with any computer or other client or server device, which can be deployed as part of a computer network or in a distributed computing environment, and can be connected to any kind of data store where media may be found. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the smooth streaming mechanisms as described for various embodiments of the subject disclosure.

FIG. 7 provides a schematic diagram of an exemplary networked or distributed computing environment. The distributed computing environment comprises computing objects 710, 712, etc. and computing objects or devices 720, 722, 724, 726, 728, etc., which may include programs, methods, data stores, programmable logic, etc., as represented by applications 730, 732, 734, 736, 738. It can be appreciated that computing objects 710, 712, etc. and computing objects or devices 720, 722, 724, 726, 728, etc. may comprise different devices, such as PDAs, audio/video devices, mobile phones, MP3 players, personal computers, laptops, etc.

Each computing object 710, 712, etc. and computing objects or devices 720, 722, 724, 726, 728, etc. can communicate with one or more other computing objects 710, 712, etc. and computing objects or devices 720, 722, 724, 726, 728, etc. by way of the communications network 740, either directly or indirectly. Even though illustrated as a single element in FIG. 7, network 740 may comprise other computing objects and computing devices that provide services to the system of FIG. 7, and/or may represent multiple interconnected networks, which are not shown. Each computing object 710, 712, etc. or computing objects or devices 720, 722, 724, 726, 728, etc. can also contain an application, such as applications 730, 732, 734, 736, 738, that might make use of an API, or other object, software, firmware and/or hardware, suitable for communication with or implementation of the smooth streaming provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the dynamic composition systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 7, as a non-limiting example, computing objects or devices 720, 722, 724, 726, 728, etc. can be thought of as clients and computing objects 710, 712, etc. can be thought of as servers where computing objects 710, 712, etc. provide data services, such as receiving data from client computing objects or devices 720, 722, 724, 726, 728, etc., storing of data, processing of data, transmitting data to client computing objects or devices 720, 722, 724, 726, 728, etc., although any computer can be considered a client, a server, or both, depending on the circumstances. Any of these computing devices may be processing data, or requesting transaction services or tasks that may implicate the techniques for dynamic composition systems as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques for performing read set validation or phantom checking can be provided standalone, or distributed across multiple computing devices or objects.

In a network environment in which the communications network/bus 740 is the Internet, for example, the computing objects 710, 712, etc. can be Web servers with which the client computing objects or devices 720, 722, 724, 726, 728, etc. communicate via any of a number of known protocols, such as the hypertext transfer protocol (HTTP). Objects 710, 712, etc. may also serve as client computing objects or devices 720, 722, 724, 726, 728, etc., as may be characteristic of a distributed computing environment.

### Exemplary Computing Device

As mentioned, advantageously, the techniques described herein can be applied to any device where it is desirable to perform dynamic composition. It is to be understood, therefore, that handheld, portable and other computing devices and computing objects of all kinds are contemplated for use in connection with the various embodiments, i.e., anywhere that a device may wish to read or write transactions from or to a data store. Accordingly, the below general purpose remote computer described below in FIG. 8 is but one example of a computing device. Additionally, a database server can include one or more aspects of the below general purpose computer, such as a media server or consuming device for the dynamic composition techniques, or other media management server components.

Although not required, embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 8 thus illustrates an example of a suitable computing system environment 800 in which one or aspects of the embodiments described herein can be implemented, although as made clear above, the computing system environment 800 is only one example of a suitable computing environment and is not intended to suggest any limitation as to scope of use or functionality. Neither is the computing environment 800 be interpreted as having any dependency or requirement relating to any one or combination of components illustrated in the exemplary operating environment 800.

With reference to FIG. 8, an exemplary remote device for implementing one or more embodiments includes a general purpose computing device in the form of a computer 810. Components of computer 810 may include, but are not limited to, a processing unit 820, a system memory 830, and a system bus 822 that couples various system components including the system memory to the processing unit 820.

Computer 810 typically includes a variety of computer readable media and can be any available media that can be accessed by computer 810. The system memory 830 may include computer storage media in the form of volatile and/or nonvolatile memory such as read only memory (ROM) and/or random access memory (RAM). By way of example, and not limitation, memory 830 may also include an operating system, application programs, other program modules, and program data.

A user can enter commands and information into the computer 810 through input devices 840. A monitor or other type of display device is also connected to the system bus 822 via an interface, such as output interface 850. In addition to a monitor, computers can also include other peripheral output devices such as speakers and a printer, which may be connected through output interface 850.

The computer 810 may operate in a networked or distributed environment using logical connections to one or more other remote computers, such as remote computer 870. The remote computer 870 may be a personal computer, a server, a router, a network PC, a peer device or other common network node, or any other remote media consumption or transmission device, and may include any or all of the elements described above relative to the computer 810. The logical connections depicted in FIG. 8 include a network 872, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to publish or consume media in a flexible way.

Also, there are multiple ways to implement the same or similar functionality, e.g., an appropriate API, tool kit, driver code, operating system, control, standalone or downloadable software object, etc. which enables applications and services to take advantage of the dynamic composition techniques. Thus, embodiments herein are contemplated from the standpoint of an API (or other software object), as well as from a software or hardware object that implements one or more aspects of the smooth streaming described herein. Thus, various embodiments described herein can have aspects that are wholly in hardware, partly in hardware and partly in software, as well as in software.

Computing devices typically include a variety of media, which can include computer-readable storage media and/or communications media, in which these two terms are used herein differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, or software. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is to be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating there from. Still further, multiple processing chips or multiple devices can share the performance of one or more functions described herein, and similarly, storage can be effected across a plurality of devices. Accordingly, the present disclosure is not to be limited to any single embodiment, but rather can be construed in breadth, spirit and scope in accordance with the appended claims.

Reference throughout this specification to “one aspect”, “an aspect”, or the like means that a particular feature, structure, or characteristic described in connection with the aspect is included in at least one aspect. Thus, the appearances of the phrase “in one aspect”, “in an aspect”, or the like in various places throughout this specification are not necessarily all referring to the same aspect. Furthermore, the particular features, structures, or characteristics may be combined in any suitable manner in one or more aspects.

As used in this application, the terms “component” “system,” or the like are generally intended to refer to a computer-related entity, either hardware (e.g., a circuit), a combination of hardware and software, software, or software in execution or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Further, the word “coupled” is used herein to mean direct or indirect electrical or mechanical coupling.

The systems and processes described herein can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not illustrated herein.

In view of the exemplary systems described above, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

What has been described above includes examples of the embodiments of the disclosed aspects. It is, of course, not possible to describe every conceivable combination of components or methods for purposes of describing the claimed subject matter, but it is to be appreciated that many further combinations and permutations of the disclosed aspects are possible. Accordingly, the claimed subject matter is intended to embrace all such alterations, modifications, and variations that fall within the spirit and scope of the appended claims. Moreover, the above description of illustrated aspects of the subject disclosure, including what is described in the Abstract, is not intended to be exhaustive or to limit the disclosed aspects to the precise forms disclosed. While specific aspects and examples are described herein for illustrative purposes, various modifications are possible that are considered within the scope of such aspects and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage medium having computer-executable instructions for performing some of the acts and/or events of the various methods of the claimed subject matter.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less that 10” can assume negative values, e.g. −1, −2, −3, −10, −20, −30, etc.

In addition, while a particular feature of the disclosed aspects may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A device, comprising:
a memory that has stored thereon computer executable components;
a microprocessor that executes the following computer executable components stored in the memory:
a format recognition component that identifies a 3D format type of a 3D video;
an extraction component that extracts 2D video frames corresponding to 3D video frames from the 3D video based on the 3D format type identified;
a collection component that generates a 2D video from the extracted 2D video frames;
a device recognition component that identifies a display device type associated with a device, and as a function of the identified display device type delivers one of the 2D video or the 3D video to the device.

2. The system of claim 1, wherein the format recognition component identifies whether the 3D format type is at least one of a side-by-side format, a top and bottom format, or an alternating format.

3. The system of claim 2, wherein the extraction component, in response to identification of the 3D format type as the side-by-side format, extracts the 2D video frames from a left portion of the 3D video frames of the 3D video or extracts the 2D video frames from a right portion of the 3D video frames of the 3D video.

4. The system of claim 2, wherein the extraction component, in response to identification of the 3D format type as the top and bottom format, extracts the 2D video frames from a top portion of the 3D video frames of the 3D video or extracts the 2D video frames from a bottom portion of the 3D video frames of the 3D video.

5. The system of claim 2, wherein the extraction component, in response to identification of the 3D format type as the alternating format, extracts odd 3D video frames of a consecutive series of 3D video frames of the 3D video as the 2D video frames or extracts even 3D video frames of a consecutive series of 3D video frames of the 3D video as the 2D video frames.

6. The system of claim 1, wherein the device recognition component determines the display device type associated with the device based upon a video request associated with the 3D video.

7. The system of claim 1, wherein the device recognition component infers the display device type associated with the device based upon information included in a video request associated with the 3D video.

8. The system of claim 1, wherein the device recognition component queries the device for information regarding the display device type associated with the device.

9. A method, comprising:
employing a processor to execute computer executable instructions stored on a computer readable medium to perform the following acts:
identifying a 3D format type of a 3D video;
extracting 2D video frames corresponding to 3D video frames from the 3D video based on the 3D format type identified;
generating a 2D video from the extracted 2D video frames;
identifying a display device type associated with a device; and
as a function of the identified display device type, delivering either the 2D video or the 3D video to the device.

10. The method of claim 9, further comprising identifying whether the 3D format type is at least one of a side-by-side format, a top and bottom format, or an alternating format.

11. The method of claim 10, further comprising, in response to identification of the 3D format type as the side-by-side format, extracting the 2D video frames from a left portion of the 3D video frames of the 3D video or extracting the 2D video frames from a right portion of the 3D video frames of the 3D video.

12. The method of claim 10, further comprising, in response to identification of the 3D format type as the top and bottom format, extracting the 2D video frames from a top portion of the 3D video frames of the 3D video or extracting the 2D video frames from a bottom portion of the 3D video frames of the 3D video.

13. The method of claim 2, further comprising, in response to identification of the 3D format type as the alternating format, extracting odd numbered 3D video frames of a consecutive series of 3D video frames of the 3D video as the 2D video frames or extracting even numbered 3D video frames of a consecutive series of 3D video frames of the 3D video as the 2D video frames.

14. The method of claim 9, further comprising determining the display device type associated with the device based upon a video request associated with the 3D video.

15. The method of claim 9, further comprising inferring the display device type associated with the device based upon information included in a video request associated with the 3D video.

16. The method of claim 9, further comprising querying the device for information regarding the display device type associated with the device.

17. A non-transitory computer-readable medium having instructions stored thereon that, in response to execution, cause at least one device to perform operations comprising:
identifying a 3D format type of a 3D video;
extracting 2D video frames corresponding to 3D video frames from the 3D video based on the 3D format type identified;
generating a 2D video from the extracted 2D video frames;
identifying a display device type associated with a device; and
as a function of the identified display device type delivering either the 2D video or the 3D video to the device.

18. The non-transitory computer-readable medium of claim 17, the operations further comprising identifying whether the 3D format type is at least one of a side-by-side format, a top and bottom format, or an alternating format.

19. The non-transitory computer-readable medium of claim 18, the operations further comprising, in response to identification of the 3D format type as the side-by-side format, extracting the 2D video frames from a left portion of the 3D video frames of the 3D video or extracting the 2D video frames from a right portion of the 3D video frames of the 3D video.

20. The non-transitory computer-readable medium of claim 18, the operations further comprising, in response to identification of the 3D format type as the top and bottom format, extracting the 2D video frames from a top portion of the 3D video frames of the 3D video or extracting the 2D video frames from a bottom portion of the 3D video frames of the 3D video.

21. The non-transitory computer-readable medium of claim 18, the operations further comprising, in response to identification of the 3D format type as the alternating format, extracting odd numbered 3D video frames of a consecutive series of 3D video frames of the 3D video as the 2D video frames or extracting even numbered 3D video frames of a consecutive series of 3D video frames of the 3D video as the 2D video frames.
